(19) United States
(12) Patent Application Publication
(10) Pub. No.: US 2020/0389427 A1
(43) Pub. Date: Dec. 10, 2020

(54) LOOPBACK ADDRESS CONFIGURATION

(71) Applicant: Cisco Technology, Inc., San Jose, CA (US)

(72) Inventors: Ian Wells, San Jose, CA (US); Kyle Mestery, Woodbury, MN (US)

(21) Appl. No.: 16/434,815

(22) Filed: Jun. 7, 2019

(51) Int. Cl. H04L 29/12; H04L 12/803; H04L 12/725; H04L 12/707

(52) U.S. Cl. CPC H04L 61/2038; H04L 47/125; H04L 45/22; H04L 45/306; H04L 61/2015

(57) ABSTRACT

A first request for a loopback address is obtained at a first device. The loopback address is associated with a service provided by a second device, and is obtained via a first interface of the second device. The loopback address is provided to the second device via the first interface. A second request for the loopback address associated with the service provided by the second device is obtained at the first device via a second interface of the second device. The loopback address is provided to the second device via the second interface. A first route to the service utilizing the loopback address and the first interface is programmed at the first device. A second route to the service utilizing the loopback address and the second interface is also programmed at the first device.

### TECHNICAL FIELD

The present disclosure relates to the configuration of network addresses, including Open System Interconnection Model Layer 3 addresses and loopback addresses.

### BACKGROUND

In related art Open System Interconnection Model Layer 3 networks, servers providing services, applications and/or functions to network traffic may connect to the networks through multiple links serviced by multiple interfaces, each of which is assigned a different external network address. Related art techniques provide protocols for automatically configuring these interfaces with the addresses used to receive traffic from the network to which the interfaces connect.

Because the services, applications and/or functions executing on the servers are internal, loopback addresses may be used to route traffic from the server interfaces to the services, applications and/or or functions. A loopback address is an address that traditionally keeps traffic within a specific device without sending the traffic into the network outside of the device. In the related art, network devices (e.g., switches and routers) are manually configured with such loopback addresses so that traffic within the network may be sent from the network to the services, applications and/or or functions executing on a server.

### BRIEF DESCRIPTION OF THE DRAWINGS

FIG. 1 is first network environment implementing the loopback address configuration techniques of the present disclosure, according to example embodiments.

FIGS. 2A-2C illustrate a first process flow between a router and a server implementing the loopback address configuration techniques of the present disclosure, according to example embodiments.

FIG. 3 is a second network environment implementing the loopback address configuration techniques of the present disclosure, according to example embodiments.

FIG. 4 illustrates of a second process flow implementing the loopback address configuration techniques of the present disclosure in a network environment like that illustrated in FIG. 3, according to example embodiments.

FIG. 5 is an illustration of a packet configured to implement the loopback address configuration techniques of the present disclosure, according to example embodiments.

FIG. 6 is a flowchart providing a process flow for implementing the loopback address configuration techniques of the present disclosure, according to example embodiments.

FIG. 7 is a functional block diagram of an apparatus configured according to the loopback address configuration techniques of the present disclosure, according to example embodiments.

### DESCRIPTION OF EXAMPLE EMBODIMENTS

### Overview

A first request for a loopback address is obtained at a first device. The requested loopback address is associated with a service, application and/or or function (hereinafter collectively referred to as a “service”) provided by a second device, and the first request is obtained via a first interface of the second device. The loopback address is provided to the second device via the first interface. A second request for the loopback address associated with the service provided by the second device is obtained at the first device via a second interface of the second device. The loopback address is provided to the second device via the second interface. A first route to the service utilizing the loopback address and the first interface is programmed at the first device. A second route to the service utilizing the loopback address and the second interface is also programmed at the first device.

### Example Embodiments

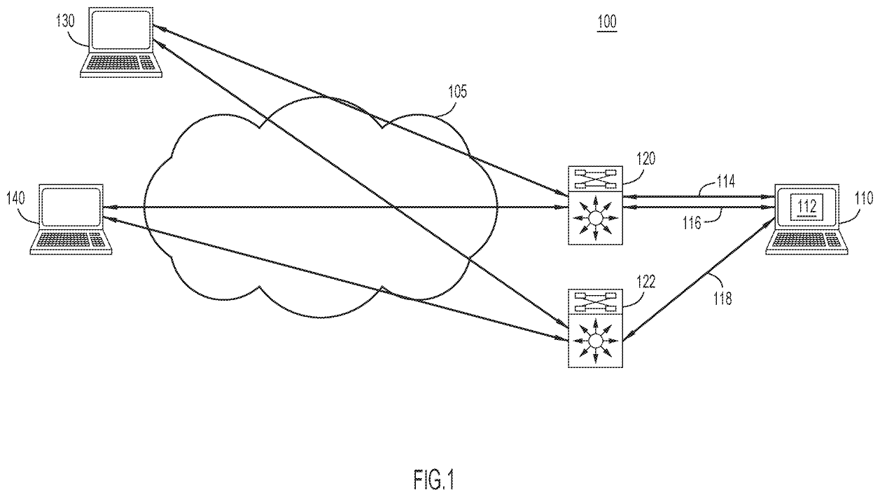

With reference made to FIG. 1, depicted therein is a network environment 100 in which a function, application or service 112 (hereinafter a “service”) is executing on server 110. Server 110 has two interfaces 114 and 116 via which network traffic from network 105 may access server 110 via router 120. According to other example embodiments, server 110 may access router 120 via more than two interfaces. Server 110 may also access network 105 through additional interfaces that access network 105 through additional routers, such as interface 118 which accesses network 105 through router 122. Network 105 of network environment 100 may include an Open Systems Interconnections (OSI) model Layer 3 fabric network. Accordingly, routers 120 and 122 may be embodied as access switches or routers in a spine and leaf network architecture. A fabric network may be viewed as an overlay or a logical topology used to virtually interconnect devices. The fabric network is built on top of a physical underlay topology that is being abstracted by the overlay. OSI Layer 3 fabric designs may be based on well-known routing protocols, such as the Border Gateway Protocol, and may offer scalability and predictability benefits to the traffic flows through the fabric.

When traffic is received at server 110 destined for service 112, interfaces 114, 116 and 118 may direct the traffic to service 112 via a loopback address. A loopback address is an internal address, such as a virtual interface, that a computing device may utilize to communicate with itself. Accordingly, a loopback address may be used to communicate within server 110 from interfaces 114 and 116 to service 112. Because server 110 contains multiple interfaces, 114, 116 and 118, traffic sent to server 110 destined for service 112 may utilize techniques such as Equal-Cost Multipath (ECMP) routing load balancing and link redundancy. For example, if appropriately configured, router 120 may route traffic to service 112 via either of interfaces 114 or 116. If traffic is sent from client 130 for application of service 112 via router 120, router 120 may route the traffic to service 112 via either of interfaces 114 or 116.

Though, in related art implementations, such loopback addresses may not be automatically configured. For example, related art auto-configuration protocols, such as the Dynamic Host Configuration Protocol (DHCP), do not provide for the auto-configuration of loopback addresses. In related art uses of loopback addresses, such addresses would only be used via the device to which the address is assigned. Accordingly, a DHCP server would not be needed to assign a loopback address to a device.

According to the techniques of the present disclosure, the destination address of traffic sent to service 112 may be configured as a loopback address within server 110. Because the traffic traversing network environment 100 destined for service 112 will be addressed with this loopback address, server 110 should be configured with the loopback address from, for example, a DHCP server to ensure that the loopback address utilized by server 110 does not conflict with other addresses within network environment 100. Therefore, according to the techniques of the present disclosure, server 110 is automatically configured with loopback addresses by, for example, router 120, router 122, and/or another device, such as a Software Defined Network (SDN) controller or a DHCP server. This automatic configuration allows traffic received over either of interfaces 114, 116 and/or 118 to be delivered to service 112 through a loopback address while avoiding conflicts with other loopback addresses in network environment 100 on its way to server 110.

The techniques of the present disclosure may also automatically configure routers 120 and 112 such that ECMP load balancing and link redundancy techniques may be implemented for traffic sent to service 112. As will be described in greater detail below, the techniques of the present disclosure implement a protocol that provides server 110 with a loopback address to use for service 112. The techniques will also result in, for example, router 120 being programmed such that the loopback address is associated with both of interfaces 114 and 116, which may enable router 120 to implement ECMP routing load balancing and link redundancy.

The techniques of the present disclosure may be implemented through router 120 and server 110, while other example embodiments may also utilize router 122 or a DHCP server, such as DHCP server 140, with router 120 or 122 serving as a DHCP relay agent. As will be described in greater detail below, example embodiments of the techniques of the present disclosure may be implemented through novel additions to the DHCP protocol or through a DHCP-like protocol.

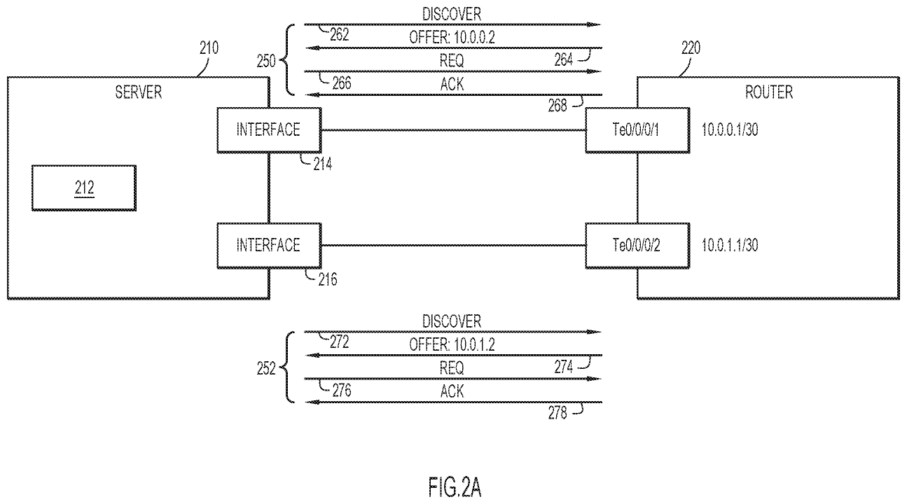

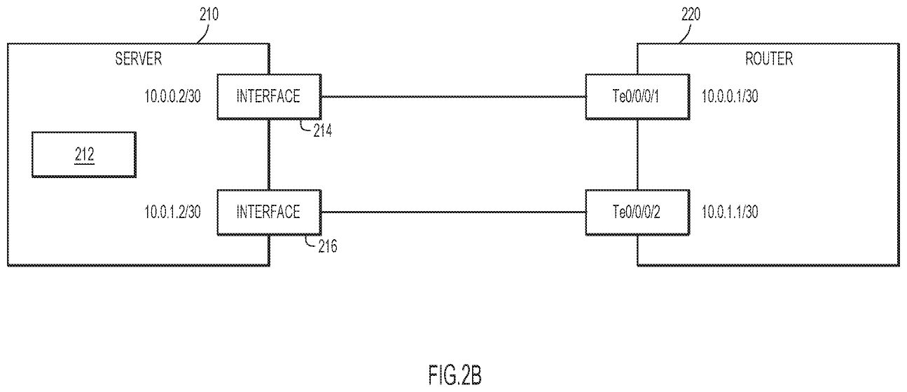

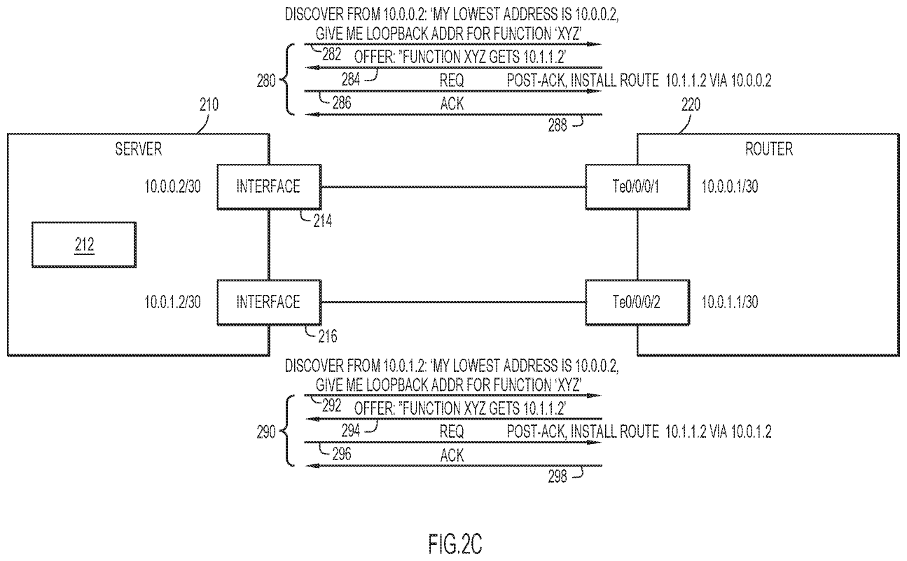

With reference now made to FIG. 2A, depicted therein is a server 210 configured to provide a service 212. Server 210 is configured with two interfaces, interface 214 and interface 216. As illustrated in FIG. 2, interface 214 and interface 216 both connect to router 220. According to other example embodiments, router 220 could be replaced by, for example, a DHCP server, such as DHCP server 140 of FIG. 1. According to such an example embodiment, the communication path between interfaces 214 and 216 may traverse additional devices. Furthermore, interfaces 214 and 216 may connect to the network environment through different routers, such as routers 120 and 122 of FIG. 1.

When server 210 initially connects through router 220 to a network environment, it may use an automatic configuration protocol, such as DHCP, to configure interfaces 214 and 216 with appropriate Internet Protocol (IP) addresses. A message exchange implementing such a configuration is illustrated through pseudo code 250 and 252 for each of interfaces 214 and 216, respectively. Specifically, interface 214 broadcasts a discovery message 262 which indicates that server 210 has connected to the network environment via interface 214. A configuration controller will respond with an offer of an Internet Protocol (IP) address through message 264. According to the example embodiment of FIG. 2A, router 220 serves as a DHCP server, and therefore, router 220 sends offer 264. Offer 264 includes a proposed IP address, in this case an address of “10.0.0.2.” Server 210 responds to offer 264 with request 266 via which server 210 requests that the address from offer 264 be assigned to interface 214. Router 220 responds with acknowledgement 268, at which point server 210 configures interface 214 with the address from offer 264. An analogous process for interface 216 is implemented through pseudocode 252 via messages 272-278. The IP address associated with offer message 274 is “10.0.1.2.” Accordingly, at the completion of the configurations, interface 214 is configured with an IP address of “10.0.0.2” and interface 216 is configured with an IP address of 10.0.1.2,” as illustrated in FIG. 2B.

Turning to FIG. 2C, depicted therein is the configuration of server 210 with a loopback address for service 212 from router 220. Specifically, each of interfaces 214 and 216 sends a discovery message, discovery messages 282 and 292, respectively. Discovery messages 282 and 292 indicate that a loopback address is needed for service 212, as well as the lowest IP address associated with server 210, i.e., the lower of the two IP addresses associated with interfaces 214 and 216. This information may be communicated in discovery messages 282 and 292 through, for example, a DHCP option value. DHCP packets may include strings of varying length that provide for different options under the DHCP protocol, which are documented in Internet Engineering Task Force (IETF) Request for Comment (RFC) 2132. Accordingly, the techniques of the present disclosure may utilize a novel DHCP option to implement the techniques of the present disclosure.

The lowest IP address associated with server 210 is used in discovery messages 282 and 292 to identify server 210. Other ways of identifying server 210 may be used in place of or in conjunction with the lowest IP address. For example, the Media Access Control (MAC) address associated with server 210 may be included in messages 282 and 292.

Specifically, DHCP options provide specific configuration and service information to DHCP clients. These options appear as variable-length fields at the end of the DHCP messages that DHCP servers and clients exchange. For example, DHCP option 3 is used to list the available routers in the network of the client and option 6 is used to list the available DNS servers. Defining a new option which indicates that DHCP discovery messages 282 and 292 are requesting loopback address may be one example embodiment implementation of the techniques of the present disclosure. According to such an embodiments, the variable length DHCP option field may be selected to be of sufficient length to communicate a label for service 212, as will be described in greater detail below.

As illustrated in the pseudocode of message exchange 280, discovery message 282 indicates that the discovery message is intended to receive an offer for a loopback address for service 212 (i.e., function “XYZ”) and that the lowest IP address associated with the interfaces of server 210 is “10.0.0.2,” which is the address associated with interface 214, the source of message 282. Message 292 of message exchange 290 also indicates that the discovery message is intended to receive an offer for a loopback address for service 212 (i.e., function “XYZ”) and that the lowest IP address associated with the interfaces of server 210 is “10.0.0.2,” which is the address associated with interface 214, not the address associated with interface 216. Both messages 282 and 292 include the lowest IP address associated with either of interfaces 214 and 216 to ensure that router 220 is aware that messages 282 and 292 are both originating from server 210. As noted above, other values identifying server 210 may be included in messages 282 and 292, such as the MAC address associated with server 210. Furthermore, because both of messages 282 and 292 indicate the same service 212 (i.e., function “XYZ”), router 220 provides the same address when it responds with offer messages 284 and 294, respectively. Router 220 responds to both interfaces 214 and 216 through offer messages 286 and 296, respectively, which offer the same IP address of “10.1.1.2” to both of interfaces 214 and 216 for assignment to service 212.

Furthermore, because the offer message includes an indication of service 212 (i.e., function “XYZ”) and not just an identifier for server 210, multiple loopback addresses may be used by server 210 if it hosts multiple services. For example, a discovery message like messages 282 and 292 that identifies the same server and interface but differ in the indication of the service may receive a different loopback address in the offer message from router 220. Accordingly, a server may be configured with multiple loopback addresses for use with multiple services. Absent such labelling, it may be difficult to determine whether other not any particular discovery message should be offered the same or different loopback addresses. The label (i.e., function “XYZ” in messages 282 and 292) may be sent according a nonce or cryptograph technique to ensure that multiple requests for the same server are in fact originating at the same server. Additionally, because discovery messages 282 and 292 are labelled with the identity of service 212 (i.e., function “XYZ” in the pseudocode 280 and 290 of FIG. 2C), message exchanges 282-288 and 292-298 may proceed simultaneously.

According to other example embodiments, the identity of the service 212 (i.e., function “XYZ” in the pseudocode 280 and 290 of FIG. 2C) may be omitted, in which case server 210 may host a single service, or the services hosted on server 210 may share a single loopback address.

As understood by the skilled artisan, loopback addresses are often assigned a value of “127.0.0.1” in related art techniques. Using a network number of “127” ensure that the traffic remains in the device utilizing the loopback address and does not appear in the network. The present disclosure may utilize loopback addresses with other network numbers, such as “10” which may be used for private IP addresses, because this traffic will appear in the network to which server 210 connects via interfaces 214 and 216. Nevertheless, because the loopback address of “10.1.1.2” is assigned to service 212 it will serve as a loopback address within server 210 even though it does not use the network number of “127.”

Interfaces 214 and 216 respond to offer messages 284 and 294 with request messages 286 and 296, respectively, which router 220 acknowledges with acknowledgement messages 288 and 298, respectively.

Subsequent to the sending of acknowledgement messages 288 and 298, router 220 installs a route to service 212 through interface 214, which includes the address for interface 214 of “10.0.0.2” and the loopback address “10.1.1.2.” Router 220 also installs a route to service 212 through interface 216, which includes the address for interface 216 of “10.0.1.2” and the loopback address “10.1.1.2.” Subsequent to receipt of acknowledgement messages 288 and 298, server 210 configures service 212 with the address of “10.1.1.2.”

Because router 220 has two installed routes to service 212, one through interface 214 and another through interface 216, router 220 may implement ECMP routing load balancing and link redundancy techniques for traffic destined for service 212. For example, if both interfaces 214 and 216 are operational, traffic received at router 220 destined for service 212 may be sent through either of interfaces 214 and 216 according to ECMP techniques. Furthermore, if either of interfaces 214 or 216 becomes inoperable, the other interface may serve as a redundant path through which traffic may be transmitted from router 220 to server 210.

Upon completion of the processing illustrated in FIG. 2C, service 212 is uniquely identified on server 210 and it is configured with two routes over two links from router 220, utilizing interfaces 214 and 216, respectively. Router 220 may implement ECMP techniques through the two routes, the two routes provide increased bandwidth and the two routes provide redundancy in the event of a route failure. Furthermore, the techniques of the present disclosure may be applied to a greater number of links if, for example, server 210 is configured with a greater number of interfaces. Furthermore, the techniques of the present disclosure do not require static configuration on both sides of the routes between server 210 and router 220 (i.e., interfaces 214 and 216 of server 210 and the corresponding interfaces on router 220 do not require static configuration).

In summary, provided for in FIGS. 2A - 2C is a process in which a DHCP-like protocol or a novel use of a DHCP option is used to reveal to a server which loopback address the server should use for an internal service, function and/or application. Because the techniques provide for an external IP address to use as a loopback address, the techniques of the present disclosure may operate at Layer 3 of the OSI model when the server is being auto configured for OSI model layer 3 based redundant paths. The address request (e.g., a DHCP discovery message) may come with a purpose indicator (i.e., an indication of the service to which the loopback address will apply), to allow for the case that a server should use multiple loopback addresses to service multiple functions. Upon acknowledgement from the router, the server, having no address for the identified purpose or service, programs the address to a loopback interface and returns its acceptance. The fabric network, via the router may then program a network mask (i.e., program a /32 route or a /128 route) configured to cover all interfaces associated with the loopback address. If the server receives further offers for an address for that purpose on other links (or, preemptively, before being offered an address), rather than accept them, it reports that it already has an address accepted for that purpose. The fabric would add additional /32 or /128 routes for the address to the new external address on the additional interface, thereby setting up both ECMP load balancing and link redundancy. If the server has a statically chosen loopback address for a purpose programmed into its software load, the server may report the pre-selected address.

The techniques of the present disclosure may also be used to indicate that Bidirectional Forwarding Detection (BFD) should be used on the loopback address and also indicate the nature of the BFD configuration. For example, BFD provides a low-overhead, short-duration method of detecting failures in the forwarding path between two adjacent routers, or in the example of FIGS. 2A-2C, between router 220 and server 210. The types of failures include failures in the interfaces, data links, and forwarding planes. BFD is a detection protocol that is enabled at the interface and routing protocol levels. Accordingly, to certain example embodiments, BFD asynchronous mode may be utilized in which BFD control packets are sent between two systems to activate and maintain BFD neighbor sessions between routers, or a router and a server. Therefore, in order for a BFD session to be created, BFD is enabled on both systems (or BFD peers). Once BFD has been enabled on the interfaces, a BFD session is created, BFD timers are negotiated, and the BFD peers will begin to send BFD control packets to each other at the negotiated interval. Using additional DHCP-like or DHCP options, BFD may be enabled on the interfaces of a router and a server, such as router 220 and server 210 of FIGS. 2A-2C.

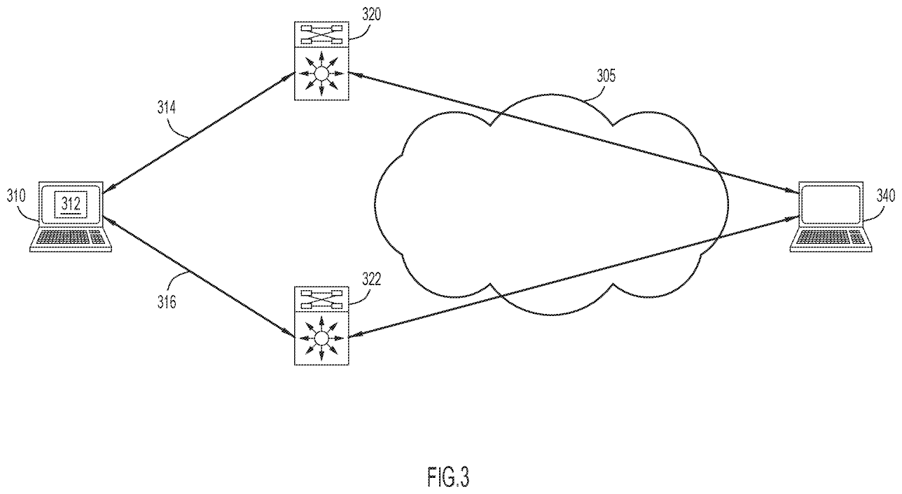

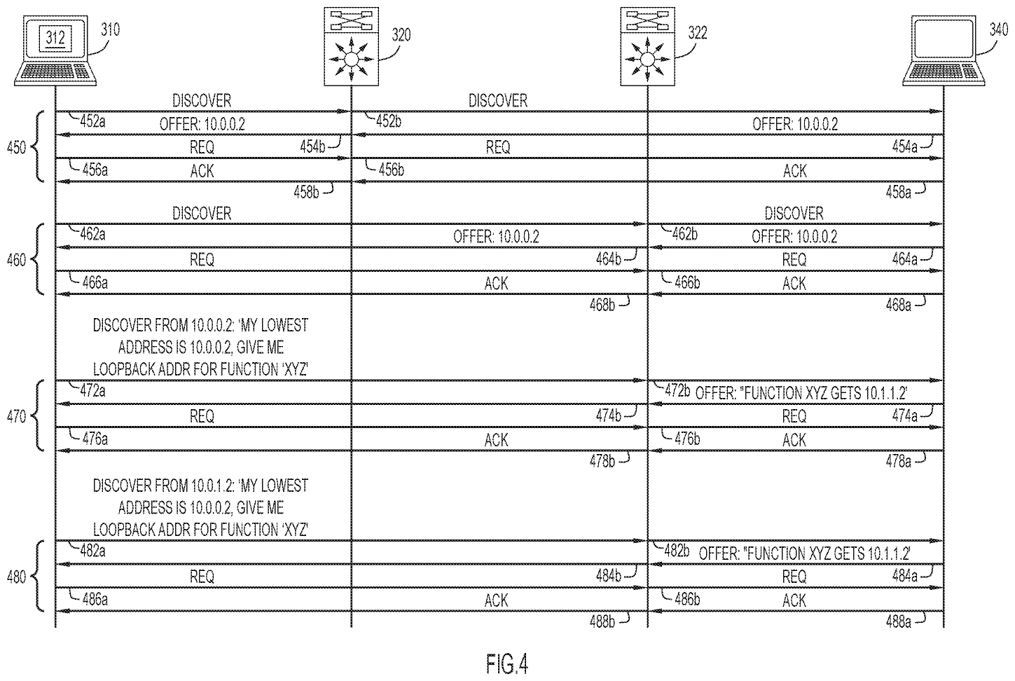

Turning to FIG. 3, depicted therein is a network environment in which server 310 includes two interfaces, interface 314 and interface 316, that connect to network 305 through different routers, router 320 and router 322, respectively. In such an environment, routers 320 and 322 serve as relay devices so that controller 340 (e.g., a DHCP server or SDN controller) may implement the automatic configuring of interfaces 314 and 316 with loopback addresses to service 312. Accordingly, the example embodiment of FIG. 3 includes a first device, a second device, a third device and a fourth device: controller 340 serves as a first device, server 310 serves as a second device, and routers 320 and 322 servers as a third device and a fourth device, respectively. The message exchanges illustrated in FIG. 4 may implement this automatic configuration.

Illustrated in FIG. 4 are an example embodiment of the message exchanges that may be used to automatically configure interfaces 314 and 316 of FIG. 3, which connect to network 305 through different routers, routers 320 and 322, respectively. Specifically, messages exchange 450 of FIG. 4 may be considered as analogous to message exchange 250 of FIG. 2A. Accordingly, server 310 broadcasts a discovery message 452a via interface 314 which indicates that server 310 has connected to the network environment via interface 314. Message 452a is received at router 320 and is forwarded to DHCP server 340 via message 452b. DHCP server 340 responds with an offer of an IP address through message 454a, which is forwarded to server 310 from router 320 through message 454b. Server 310 responds to offer 454b with request 456a via which server 310 requests that the address from offer 454b be assigned to interface 314. Router 320 forwards message 456a to DHCP server 340 via message 456b. DHCP server 340 responds with acknowledgement 458a which is forwarded from router 320 to server 310 via message 458b. At this point server 310 configures interface 314 with the address from offer 454b. An analogous process for interface 316 is implemented through message exchange 460 via messages 462a and 462b through 468a and 468b, with router 322 forwarding the messages between server 310 and DHCP server 340.

Message exchange 470 may be viewed as analogous to exchange 280 of FIG. 2C. Accordingly, discovery message 472a indicates that the discovery message is intended to receive an offer for a loopback address for service 312 (i.e., function “XYZ”) and that the lowest IP address associated with the interfaces of server 310 is “10.0.0.2,” which is the address associated with interface 314, the source of message 472a. Message exchange 480 is analogous to exchange 290 of FIG. 2C, and therefore, message 482a also indicates that the discovery message is intended to receive an offer for a loopback address for service 312 (i.e., function “XYZ”) and that the lowest IP address associated with the interfaces of server 310 is “10.0.0.2,” which is the address associated with interface 314, not the address associated with interface 316. Both messages 472a and 482a include the lowest IP address associated with either of interfaces 314 and 316 to ensure that DHCP server 340 is aware that messages 472b and 482b (forwarded to DHCP server 340 via routers 320 and 322, respectively) are both originating from server 310. As noted above, other values identifying server 310 may be included in these messages, such as the MAC address associated with server 310. Furthermore, because both of messages 472b and 482b indicate the same service (i.e., function “XYZ”), DHCP server 340 provides the same address when it responds with offer messages 474a and 484a, respectively. Offer messages 474a and 484a, for interfaces 314 and 316, respectively, offer the same IP address of “10.1.1.2” to both of interfaces 314 and 316 for assignment to service 312. Offer messages 474a and 484a, respectively, are forwarded to server 310 via message 474b a and 484b. Messages 476a, 476b, 478a and 478b complete the process of message exchange 470, while messages 486a, 486b, 488a and 488b compete the process of message exchange 480, which result in service 312 being assigned the loopback address of “10.1.1.2” accessible via the two interfaces of server 310 from routers 320 and 322, respectively.

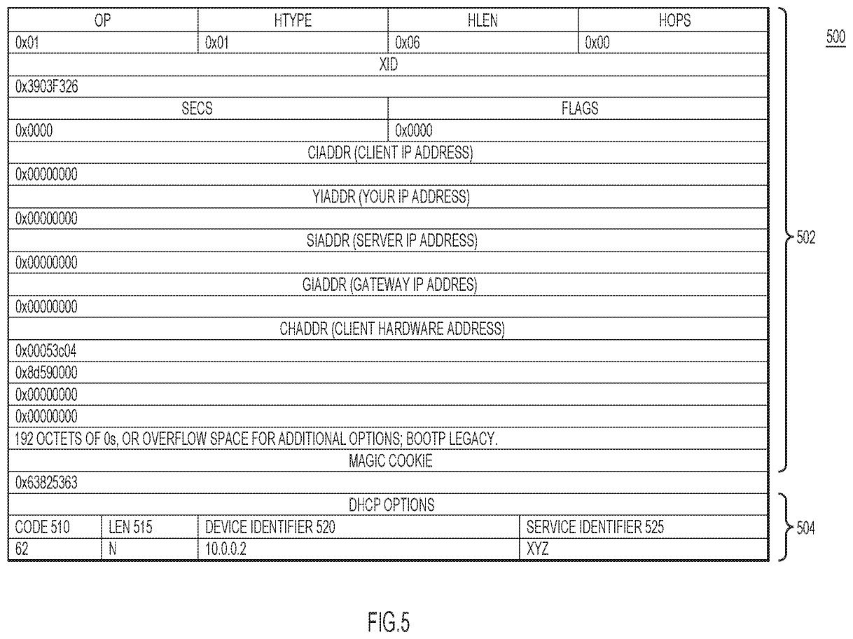

With reference now made to FIG. 5, depicted therein is an example packet 500 configured to carry out the techniques of the present disclosure. Specifically, packet 500 is illustrated as a DHCP discovery packet that includes DHCP discovery portion 502, which corresponds to related art DHCP discovery packets, and DHCP option portion 504 though which the techniques of the present application are implemented. DHCP options portion 504 includes code field 510, which indicates that the packet is requesting a loopback address. Accordingly, packet 500 may be an example embodiment of one or more of messages 282 and 292 of FIG. 2C, or messages 472a, 472b, 482a or 482b of FIG. 4. A value of “62” has been included in code field 510 as this code value is not currently used by either of RFC 1533 or RFC 2132 the Internet Engineering Task Force (IETF) Requests for Comment (RFCs) defining the DHCP Options and BOOTP Vendor Extensions, the contents of which are hereby incorporated by reference in their entirety.

Length field 515 includes the length for DHCP option field 504. Device Identifier field 520 provides an identifier for the device to which the loopback address will be assigned. For example, if this field were used in the process flow of FIG. 2C, device identifier field 520 would include the lowest IP address associated with server 210, i.e., “10.0.0.2.” According to other example embodiments, device identifier field 520 may be populated with a MAC address or other identifier that will identify within a network environment the device requesting the loopback address. Service identifier field 525 may be used to identify the service to which the loopback address will be applied by the device identified in device identifier field 520. For example, if packet 500 serves as message 282 or 292 of FIG. 2C, the service identifier field will be populated with the value of “XYZ” as this is the identifier for the service for which the loopback address is being requested in FIG. 2C. According to other example embodiments, this field may be left blank if only a single service will be hosted by the device identified in identifier field 520. Fields analogous to those illustrated in FIG. 5 may be used in DHCP version 4, DHCP version 6 and/or other version of the DHCP protocol without deviating from the techniques of the present disclosure.

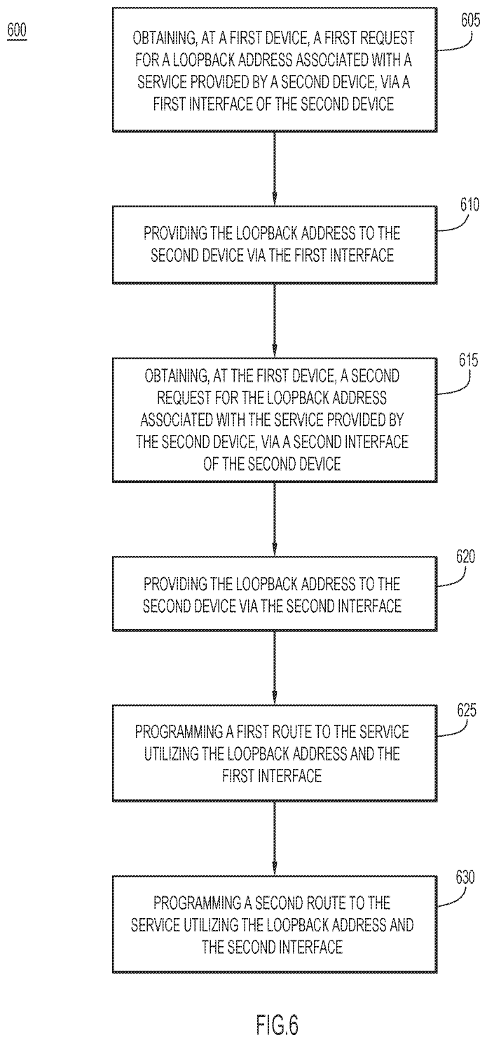

With reference now made to FIG. 6, depicted therein is a process flow 600 providing an example embodiment of the techniques of the present disclosure. Process flow 600 begins in operation 605 where a first request is obtained at a first device for a loopback address associated with a service provided by a second device. The request is obtained from a first interface of the second device. For example, the request of operation 605 may be a DHCP discovery message such as messages 282 and/or 292 of FIG. 2C or messages 472a/b and/or 482a/b of FIG. 4. In operation 610, the loopback address is provided to the second device via the first interface. Example embodiments of operation 610 may include offer messages 284 or 294 of FIG. 2C or messages 474a/b and/or 484a/b of FIG. 4. According to other example embodiments, operations 605 through 610 may include a message exchange that facilitates the operations of both of messages exchanges 250 and 280 of FIGS. 2A and 2C into a single message exchange. For example, a single discovery message may be configured to request both of an address for an interface and an address for a service hosted on the device associated with the interface. Similarly, a single offer message may reply with addresses for the interface and service. Analogously, operations 605 through 610 may implement message exchanges 252 and 290 of FIGS. 2A and 2C, message exchanges 450 and 470 of FIG. 4 and message exchanges 460 and 480 also of FIG. 4.

In operation 615, a second request is obtained at the first device via a second interface of the second device. The second request is configured to request the loopback address for the service, but is for a path via the second interface of the second device. If the first request is embodied as discovery message 282 of FIG. 2C, the second request may be embodied as discovery message 292 of FIG. 2C, and vice versa. If the first request is embodied as discovery message 472a/b of FIG. 4, the second request may be embodied as discovery message 484a/b of FIG. 4, and vice versa. Operation 615 may take place before, after or concurrently with operation 605. In operation 620 the loopback address is provided to the second device via the second interface. Example embodiments of operation 620 may include offer message 284 or 294 of FIG. 2C or messages 474a/b and/or 484a/b of FIG. 4. Operation 620 may take place before, after or concurrently with operation 610.

In operation 625 a first route to the service is programmed at the first device that utilizes the loopback address and the first interface, while in operation 630 a second route to the service is programmed at the first device that utilizes the loopback address and the second interface. According to example embodiments, the programming of the first and second routes may include the programming of router 220 with routes to service 212 via interfaces 214 and 216, as described above with reference to FIG. 2C or the programming of DHCP server 340 with routes to service 312 via interfaces 314 and 316 of FIGS. 3 and 4. Operation 630 may take place before, after or concurrently with operation 625.

The process flow 600 of FIG. 3 may include additional steps, such as the initial assignment of addresses to the first and second interfaces as illustrated in FIG. 2A. Process flow 600 may also include subsequent steps, such applying ECMP load balancing and link redundancy techniques to traffic being sent to the service via the first device. The process flow 600 may also be utilized to implement additional functionality, such as BFD signaling between the first and second devices over the first and second interfaces.

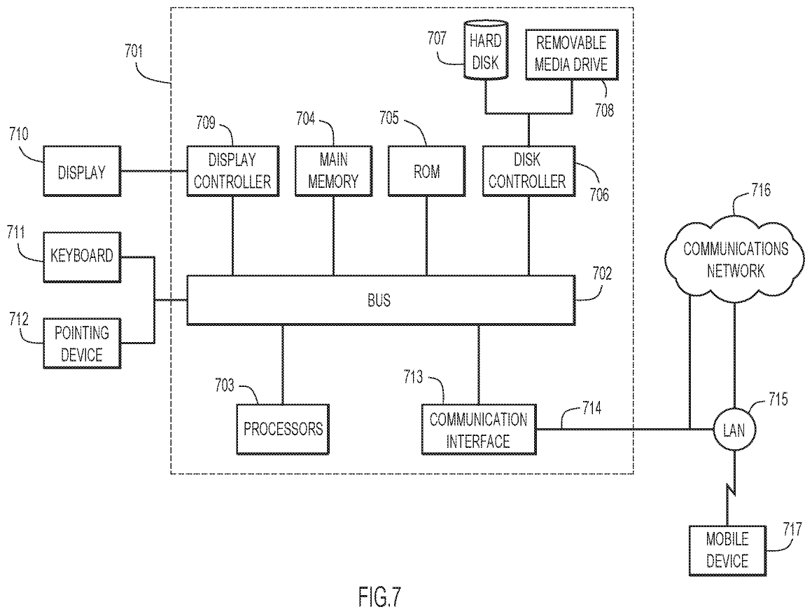

With reference now made to FIG. 7, depicted therein is an apparatus configured to implement the techniques of the present disclosure. Specifically, illustrated in FIG. 7 is an apparatus that may be configured to implement any of the functions described above with reference to FIGS. 1-6. FIG. 7 illustrates a computer system 701 upon which the embodiments presented may be implemented. The computer system 701 may be programmed to implement a computer based device. The computer system 701 includes a bus 702 or other communication mechanism for communicating information, and a processor 703 coupled with the bus 702 for processing the information. While the figure shows a single block 703 for a processor, it should be understood that the processors 703 represent a plurality of processing cores, each of which can perform separate processing. The computer system 701 also includes a main memory 704, such as a random access memory (RAM) or other dynamic storage device (e.g., dynamic RAM (DRAM), static RAM (SRAM), and synchronous DRAM (SD RAM)), coupled to the bus 702 for storing information and instructions to be executed by processor 703. In addition, the main memory 704 may be used for storing temporary variables or other intermediate information during the execution of instructions by the processor 703.

The computer system 701 further includes a read only memory (ROM) 705 or other static storage device (e.g., programmable ROM (PROM), erasable PROM (EPROM), and electrically erasable PROM (EEPROM)) coupled to the bus 702 for storing static information and instructions for the processor 703.

The computer system 701 also includes a disk controller 706 coupled to the bus 702 to control one or more storage devices for storing information and instructions, such as a magnetic hard disk 707 or solid state drive, and a removable media drive 708 (e.g., floppy disk drive, read-only compact disc drive, read/write compact disc drive, removable magneto-optical drive and optical storage drive). The storage devices may be added to the computer system 701 using an appropriate device interface (e.g., small computer system interface (SCSI), integrated device electronics (IDE), enhanced-IDE (E-IDE), direct memory access (DMA), or ultra-DMA), or any other technologies now known or hereinafter developed.

The computer system 701 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)), that, in addition to microprocessors and digital signal processors may individually, or collectively, are types of processing circuitry. The processing circuitry may be located in one device or distributed across multiple devices.

The computer system 701 may also include a display controller 709 coupled to the bus 702 to control a display 710, such as a Liquid Crystal Display (LCD), Light Emitting Diode (LED) display, or other now known or hereinafter developed display technologies, for displaying information to a computer user. The computer system 701 includes input devices, such as a keyboard 711 and a pointing device 712, for interacting with a computer user and providing information to the processor 703. The pointing device 712, for example, may be a mouse, a trackball, a pointing stick or a touch-pad, for communicating direction information and command selections to the processor 703 and for controlling cursor movement on the display 710. The display 710 may be a touch-screen display.

The computer system 701 performs a portion or all of the processing steps of the process in response to the processor 703 executing one or more sequences of one or more instructions contained in a memory, such as the main memory 704. Such instructions may be read into the main memory 704 from another computer readable medium, such as a hard disk or solid state drive 707 or a removable media drive 708. One or more processors in a multi-processing arrangement may also be employed to execute the sequences of instructions contained in main memory 704. In alternative embodiments, hard-wired circuitry may be used in place of or in combination with software instructions. Thus, embodiments are not limited to any specific combination of hardware circuitry and software.

As stated above, the computer system 701 includes at least one computer readable medium or memory for holding instructions programmed according to the embodiments presented, for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SD RAM, or any other magnetic medium, compact discs (e.g., CD-ROM), or any other optical medium, punch cards, paper tape, or other physical medium with patterns of holes, or any other medium from which a computer can read.

Stored on any one or on a combination of non-transitory computer readable storage media, embodiments presented herein include software for controlling the computer system 701, for driving a device or devices for implementing the process, and for enabling the computer system 701 to interact with a human user (e.g., print production personnel). Such software may include, but is not limited to, device drivers, operating systems, development tools, and applications software. Such computer readable storage media further includes a computer program product for performing all or a portion (if processing is distributed) of the processing presented herein.

The computer code devices may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

The computer system 701 also includes a communication interface 713 coupled to the bus 702. The communication interface 713 provides a two-way data communication coupling to a network link 714 that is connected to, for example, a local area network (LAN) 715, or to another communications network 716 such as the Internet. For example, the communication interface 713 may be a wired or wireless network interface card to attach to any packet switched (wired or wireless) LAN. As another example, the communication interface 713 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 713 sends and receives electrical, electromagnetic or optical signals that carry digital data streams representing various types of information.

The network link 714 typically provides data communication through one or more networks to other data devices. For example, the network link 714 may provide a connection to another computer through a local area network 715 (e.g., a LAN) or through equipment operated by a service provider, which provides communication services through a communications network 716. The local network 714 and the communications network 716 use, for example, electrical, electromagnetic, or optical signals that carry digital data streams, and the associated physical layer (e.g., CAT 5 cable, coaxial cable, optical fiber, etc.). The signals through the various networks and the signals on the network link 714 and through the communication interface 713, which carry the digital data to and from the computer system 701 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 701 can transmit and receive data, including program code, through the network(s) 715 and 716, the network link 714 and the communication interface 713. Moreover, the network link 714 may provide a connection through a LAN 715 to a mobile device 717 such as a personal digital assistant (PDA) laptop computer, or cellular telephone.

The process flows, flowcharts and block diagrams in the figures illustrate the architecture, functionality, and operation of possible implementations of systems, methods, and computer program products according to various embodiments. In this regard, each block in the flowchart, process flow or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In summary, provided for herein are techniques for using a network protocol to address loopback interfaces on servers when used as a part of an OSI Model Layer 3 fabric network. The techniques of the present disclosure provide for methods that include obtaining, at a first device, a first request for a loopback address associated with a service provided by a second device, via a first interface of the second device; providing the loopback address to the second device via the first interface; obtaining, at the first device, a second request for the loopback address associated with the service provided by the second device, via a second interface of the second device; providing the loopback address to the second device via the second interface; programming a first route to the service utilizing the loopback address and the first interface; and programming a second route to the service utilizing the loopback address and the second interface.

The methods according to the techniques of the present disclosure may further provide for obtaining, at the first device, traffic addressed to the service using the loopback address; and load balancing the traffic between the first route and the second route. Other aspects of the techniques of the present disclosure may also provide for obtaining, at the first device, an indication that the first route is inoperable; and utilizing the second route to provide traffic to the service from the first device in response to obtaining the indication.

According to specific implementations of the techniques of the present disclosure, obtaining the first request includes obtaining a Dynamic Host Configuration Protocol message. Furthermore, a Dynamic Host Configuration Protocol option of the Dynamic Host Configuration Protocol message may be used to indicate that the first request is for the loopback address. In other specific implementations of the techniques of the present disclosure, the first request indicates that Bidirectional Forwarding Detection should be implemented between the first interface and the first device. According to other specific implementation of the techniques of the present disclosure, the loopback address includes a private Internet Protocol address. The techniques of the present disclosure also provide for implementations in which the first interface and the second interface access a network via the first device, as well as for implementations in which the first interface accesses a network via a third device and the second interface accesses the network via a fourth device.

Also provided for herein are apparatuses that include one or more memories, one or more network interfaces, and one or more processors. The one or more processors are configured to: obtain, via the one or more network interfaces, a first request for a loopback address associated with a service provided by a first device, via a first interface of the first device; provide the loopback address to the first device via the first interface; obtain, via the one or more network interfaces, a second request for the loopback address associated with the service provided by the first device, via a second interface of the first device; provide the loopback address to the first device via the second interface; program into the one or more memories a first route to the service utilizing the loopback address and the first interface; and program into the one or more memories a second route to the service utilizing the loopback address and the second interface.

The one or more processors may be further configured to obtain, via the one or more network interfaces, traffic addressed to the service using the loopback address; and load balance the traffic between the first route and the second route. The one more processors may also be configured to obtain, via the one or more network interfaces, an indication that the first route is inoperable; and utilize the second route to provide traffic to the service from the first device in response to obtaining the indication.

According to specific implementations of the techniques of the present disclosure, the one or more processors are configured to obtain the first request as a Dynamic Host Configuration Protocol message. Furthermore, a Dynamic Host Configuration Protocol option of the Dynamic Host Configuration Protocol message may be used to indicate that the first request is for the loopback address. The one or more processors may be configured such that it may be determined from the first request that Bidirectional Forwarding Detection should be implemented between the first interface and the first device. According to other specific implementation of the techniques of the present disclosure, the one or more processors are configured to provide loopback addresses that includes private Internet Protocol addresses. The techniques of the present disclosure also provide for implementations in which the apparatuses are arranged in network environments where the first interface and the second interface access a network via the apparatus, as well as network environments where the first interface accesses a network via a second device and the second interface accesses the network via a third device.

The techniques of the present application also provide for one or more tangible, non-transitory computer readable media encoded with instructions. The instructions, when executed by a processor, are operable to obtain, at a first device, a first request for a loopback address associated with a service provided by a second device, via a first interface of the second device; provide the loopback address to the second device via the first interface; obtain, at the first device, a second request for the loopback address associated with the service provided by the second device, via a second interface of the second device; provide the loopback address to the second device via the second interface; program, at the first device, a first route to the service utilizing the loopback address and the first interface; and program, at the first device, a second route to the service utilizing the loopback address and the second interface.

The computer readable media may also contain instructions operable to obtain, at the first device, traffic addressed to the service using the loopback address; and load balance the traffic between the first route and the second route. The computer readable media may also contain instructions operable to obtain, at the first device, an indication that the first route is inoperable; and utilize the second route to provide traffic to the service from the first device in response to obtaining the indication.

According to specific implementations of the techniques of the present disclosure, the instructions operable to obtain the first request are operable to obtain a Dynamic Host Configuration Protocol message. Furthermore, a Dynamic Host Configuration Protocol option of the Dynamic Host Configuration Protocol message may be used to indicate that the first request is for the loopback address. In other specific implementations of the techniques of the present disclosure, the first request indicates that Bidirectional Forwarding Detection should be implemented between the first interface and the first device. According to other specific implementation of the techniques of the present disclosure, the loopback address includes a private Internet Protocol address. The computer readable media may be implemented in environments where the first interface and the second interface access a network via the first device, as well as network environments where the first interface accesses a network via a third device and the second interface accesses the network via a fourth device.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
obtaining, at a first device, a first request for a loopback address associated with a service provided by a second device, via a first interface of the second device;
providing the loopback address to the second device via the first interface;
obtaining, at the first device, a second request for the loopback address associated with the service provided by the second device, via a second interface of the second device;
providing the loopback address to the second device via the second interface;
programming, at the first device, a first route to the service utilizing the loopback address and the first interface; and
programming, at the first device, a second route to the service utilizing the loopback address and the second interface.

2. The method of claim 1, further comprising:
obtaining, at the first device, traffic addressed to the service using the loopback address; and
load balancing the traffic between the first route and the second route.

3. The method of claim 1, wherein obtaining the first request comprises obtaining a Dynamic Host Configuration Protocol message.

4. The method of claim 3, wherein a Dynamic Host Configuration Protocol option of the Dynamic Host Configuration Protocol message indicates that the first request is for the loopback address.

5. The method of claim 1, wherein the first request indicates that Bidirectional Forwarding Detection should be implemented between the first interface and the first device.

6. The method of claim 1, further comprising:
obtaining, at the first device, an indication that the first route is inoperable; and
utilizing the second route to provide traffic to the service from the first device in response to obtaining the indication.

7. The method of claim 1, wherein the loopback address comprises a private Internet Protocol address.

8. The method of claim 1, wherein the first interface and the second interface access a network via the first device.

9. The method of claim 1, wherein the first interface accesses a network via a third device and the second interface accesses the network via a fourth device.

10. An apparatus comprising:
one or more memories;
one or more network interfaces; and
one or more processors configured to:
obtain, via the one or more network interfaces, a first request for a loopback address associated with a service provided by a first device, via a first interface of the first device;
provide the loopback address to the first device via the first interface;
obtain, via the one or more network interfaces, a second request for the loopback address associated with the service provided by the first device, via a second interface of the first device;
provide the loopback address to the first device via the second interface;
program into the one or more memories a first route to the service utilizing the loopback address and the first interface; and
program into the one or more memories a second route to the service utilizing the loopback address and the second interface.

11. The apparatus of claim 10, wherein the one or more processors are further configured to:
obtain, via the one or more network interfaces, traffic addressed to the service using the loopback address; and
load balance the traffic between the first route and the second route.

12. The apparatus of claim 10, wherein the one or more processors are configured to obtain the first request by obtaining a Dynamic Host Configuration Protocol message.

13. The apparatus of claim 12, wherein a Dynamic Host Configuration Protocol option of the Dynamic Host Configuration Protocol message indicates that the first request is for the loopback address.

14. The apparatus of claim 10, wherein the first request indicates that Bidirectional Forwarding Detection should be implemented between the first interface and the first device.

15. The apparatus of claim 10, wherein the one or more processors are further configured to:
obtain, via the one or more network interfaces, an indication that the first route is inoperable; and
utilize the second route to provide traffic to the service from the apparatus in response to obtaining the indication.

16. One or more tangible non-transitory computer readable media encoded with instructions, wherein the instructions, when executed by one or more processors are operable to:
obtain, at a first device, a first request for a loopback address associated with a service provided by a second device, via a first interface of the second device;
provide the loopback address to the second device via the first interface;
obtain, at the first device, a second request for the loopback address associated with the service provided by the second device, via a second interface of the second device;
provide the loopback address to the second device via the second interface;
program, at the first device, a first route to the service utilizing the loopback address and the first interface; and
program, at the first device, a second route to the service utilizing the loopback address and the second interface.

17. The one or more tangible non-transitory computer readable media of claim 16, further comprising instructions operable to:
obtain, at the first device, traffic addressed to the service using the loopback address; and
load balancing the traffic between the first route and the second route.

18. The one or more tangible non-transitory computer readable media of claim 16, wherein the instructions operable to obtain the first request comprise instructions operable to obtain a Dynamic Host Configuration Protocol message.

19. The one or more tangible non-transitory computer readable media of claim 18, wherein a Dynamic Host Configuration Protocol option of the Dynamic Host Configuration Protocol message indicates that the first request is for the loopback address.

20. The one or more tangible non-transitory computer readable media of claim 16, wherein the first request indicates that Bidirectional Forwarding Detection should be implemented between the first interface and the first device.
